(19) United States
(12) Patent Application Publication
(10) Pub. No.: US 2006/0269651 A1
(43) Pub. Date: Nov. 30, 2006

(54) Metal mold apparatus

(75) Inventor: Hiroaki Hirao, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/435,158

(22) Filed: May 15, 2006

(30) Foreign Application Priority Data
May 25, 2005 (JP) P2005-152547

(51) Int. Cl. B29C 45/00

(52) U.S. Cl. 425/556

(57) ABSTRACT

According to one embodiment, a metal mold apparatus includes: a pair of metal molds defining a molding space into which a melted resin material is filled; and an ejector pin provided in one of the metal molds and capable of protruding toward the molding space; wherein the ejector pin has a vent passage which connects the molding space and the exterior of the one metal mold.

### CROSS-REFERENCE TO RELATED APPLICATIONS

This application is based upon and claims the benefit of priority from Japanese Patent Application No. 2005-152547, filed May 25, 2005, the entire contents of which are incorporated herein by reference.

### BACKGROUND

1. Field

One embodiment of the invention relates to a metal mold apparatus which is employed in molding the casing of an electronic equipment, for example, a portable computer, and more particularly to a structure for drawing out air or gas from a molding space into which a melted resin material is filled.

2. Description of the Related Art

A casing for a portable computer is often molded of a resin material in order to realize the smaller size and lighter weight of a product. In general, resin products of this sort are mass-produced using a metal mold apparatus. The metal mold apparatus includes a pair of metal molds which are combined so as to be openable and closable, and a molding space is formed between the metal molds. The molding space defines a shape corresponding to the resin product, and the resin material which is melted is poured into the molding space and then hardened, whereby the resin product having a desired shape is obtained.

Meanwhile, at a stage before the pouring of the resin material into the molding space, this molding space is filled up with air. Therefore, in order to spread the resin material uniformly every nook and corner of the molding space, the air remaining in the molding space needs to be promptly discharged.

More specifically, when the air remains in the molding space at the pouring of the resin material into this molding space, the remaining air hampers the smooth flow of the resin material. As a result, the resin product after the completion of the molding becomes a defective article whose shape is partly deficient. Also, since the resin material touches the air remaining in the molding space, the surface of the resin product might be baked by frictional heat attendant upon the touch.

Moreover, the resin material which is poured into the molding space contains various additives, for example, a fire retardant. Depending upon the sorts of resin materials, therefore, the additives vaporize and produce a large quantity of gas when the resin material is poured into the molding space. The gas also forms one factor for hampering the flow of the resin material within the molding space.

Accordingly, the promotion of the discharge of the air and the gas within the molding space is required for ensuring the flowability of the resin material within the molding space.

As a measure for the discharge, a degassing core for discharging the air or the gas from the molding space is assembled in the related-art metal mold apparatus. A core pin which has a very fine vent hole, or a core block in which a plurality of plates having degassing grooves are placed one over the other and are joined together, has been known as the degassing core.

Each of the core pin and the core block is used in a state where it is embedded in that inner surface of the metal mold which is exposed to the molding space. Therefore, the core pin or the core block has a vent face which is flush with the inner surface of the metal mold, and the vent hole or the degassing grooves is/are open to the vent face.

Accordingly, the air remaining in the molding space or the gas produced during the pouring of the resin material is drawn out of the metal molds through the vent hole or the degassing grooves (refer to, for example, Catalog of Plastics Molding Standard Components, 2003. 5→2005. 4, P. 487-488 and P. 1015-1016, issued by MISUMI Corporation).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary sectional view of a metal mold apparatus according to an embodiment of the present invention;

FIG. 2 is an exemplary sectional view showing the positional relationship between an ejector pin and a guide slot of a first metal mold of the embodiment;

FIG. 3 is an exemplary side view of the ejector pin according to the embodiment;

FIG. 4A is an exemplary plan view of the ejector pin according to the embodiment, while FIG. 4B is a sectional view of a body of the ejector pin according to the embodiment;

FIG. 5 is an exemplary sectional view taken along line F5-F5 of in FIG. 2;

FIG. 6 is an exemplary sectional view taken along line F6-F6 of FIG. 2;

FIG. 7 is an exemplary sectional view showing a state where the ejector pin has pushed up a molded article;

FIG. 8 is an exemplary sectional view showing a state where a head portion and a groove portion of the ejector pin, and an upper end of the body of this ejector pin are exposed out of the first metal mold;

FIG. 9 is an exemplary perspective view showing a casing for a personal computer as an example of a molded article which is fabricated by the metal mold apparatus; and

FIG. 10 is an exemplary plan view showing the positional relationship between the molded article and the ejector pins for ejecting this molded article.

### DETAILED DESCRIPTION

Various embodiments according to the invention will be described below in detail with reference to the drawings. In general, according to one embodiment of the invention, a metal mold apparatus includes: a pair of metal molds defining a molding space into which a melted resin material is filled; and an ejector pin provided in one of the metal molds and capable of protruding toward the molding space; wherein the ejector pin has a vent passage which connects the molding space and the exterior of the one metal mold.

Now, an embodiment of the present invention will be described with reference to the drawings.

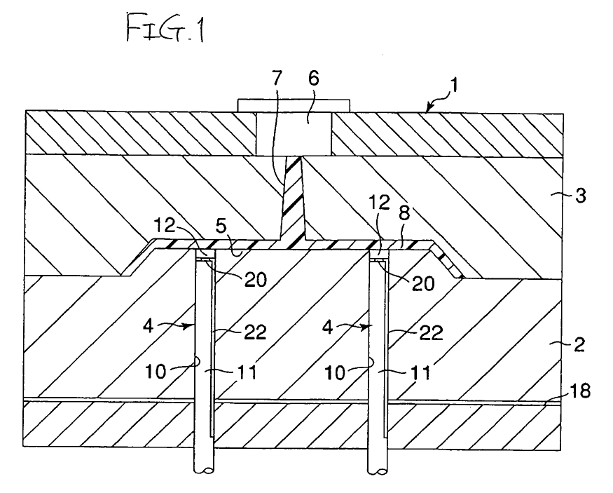

FIG. 1 shows a metal mold apparatus 1 for resin molding. The metal mold apparatus 1 includes a first metal mold 2, a second metal mold 3, and a plurality of ejector pins 4.

The first metal mold 2 and the second metal mold 3 are combined so as to be splittable in a vertical direction. The first and second metal molds 2 and 3 define a molding space 5 when both are butted against each other. The molding space 5 lies between the first metal mold 2 and the second metal mold 3.

The second metal mold 3 has a gate 6. The gate 6 serves to pour a melted resin material into the molding space 5 under a predetermined pressure, and it is contiguous to the central part of the molding space 5 through an introduction port 7. FIG. 1 shows a state where the resin material is filled into the molding space 5. The resin material filled into the molding space 5 is hardened within the molding space 5, thereby to form a molded article 8 of desired shape.

In this embodiment, polycarbonate resin or ABS resin is employed as the resin material, and this resin material contains various additives, for example, a fire retardant.

The ejector pins 4 serve to push up the molded article 8 from the first metal mold 2 and to take out this molded article, and they are assembled in the first metal mold 2. These ejector pins 4 are dispersively arranged over the wide range of the molded article 8 so that the molded article 8 can be pushed up without being inclined.

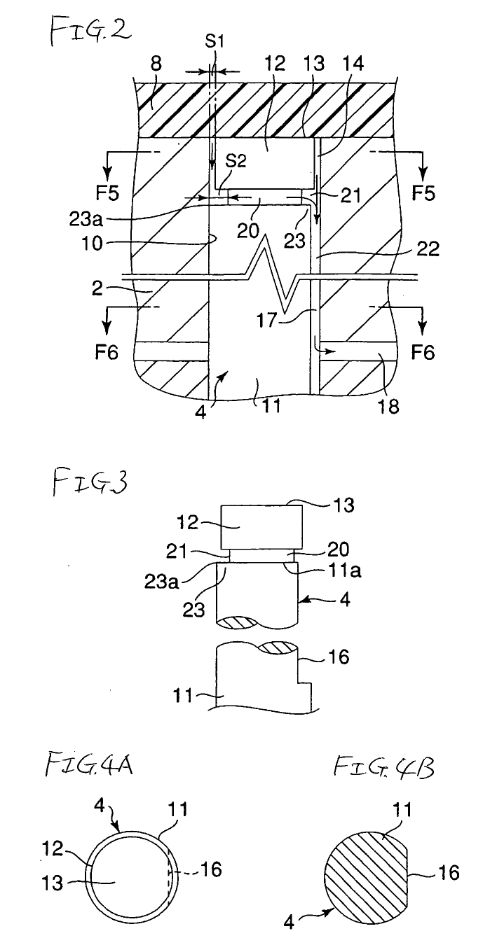

As shown in FIGS. 2 through 4, the ejector pins 4 are columnar and are respectively inserted into a plurality of guide slots 10 provided in the first metal mold 2. The guide slots 10 are open to the molding space S at positions not being opposite to the introduction port 7 into which the resin material flows.

Each of the ejector pins 4 includes a body 11 and a head portion 12. The body 11 is supported in the guide slot 10 so as to be slidable in its axial direction. The head portion 12 is provided at the upper end of the body 11 being the distal end thereof, so as to be coaxial with this body, and it has a pressing face 13 exposed to the molding space 5.

The ejector pin 4 is supported in the first metal mold 2 so as to be capable of ascending and descending between a first position and a second position. At the first position, as shown in FIG. 2, the pressing face 13 of the ejector pin 4 is exposed to the molding space 5 in a manner to be flush with the inner surface of the first metal mold 2. At the second position, as shown in FIG. 8, the pressing face 13 of the ejector pin 4 is protrusive from the inner surface of the first metal mold 2 toward the molding space 5.

Therefore, at the point of time at which the resin material is filled into the molding space 5, the ejector pin 4 descends to the first position, and its pressing face 13 functions also as the inner surface of the first metal mold 2. When the ejector pin 4 ascends from the first position to the second position, the molded article 8 is pushed up from the inner surface of the first metal mold 2.

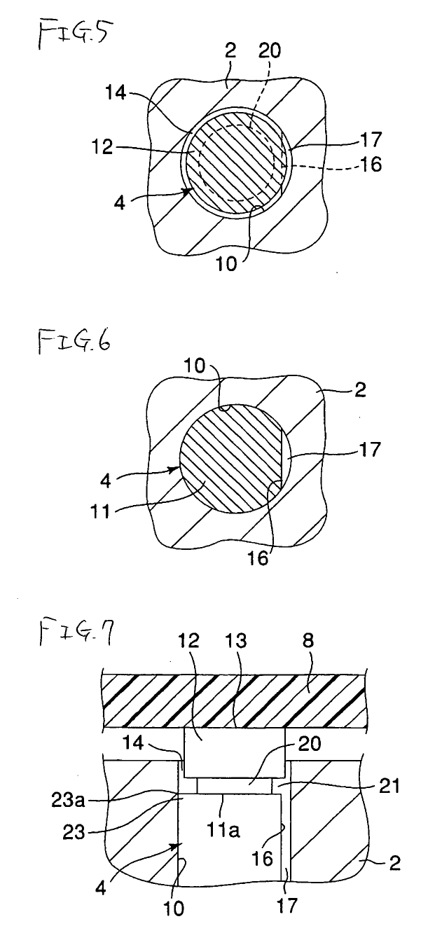

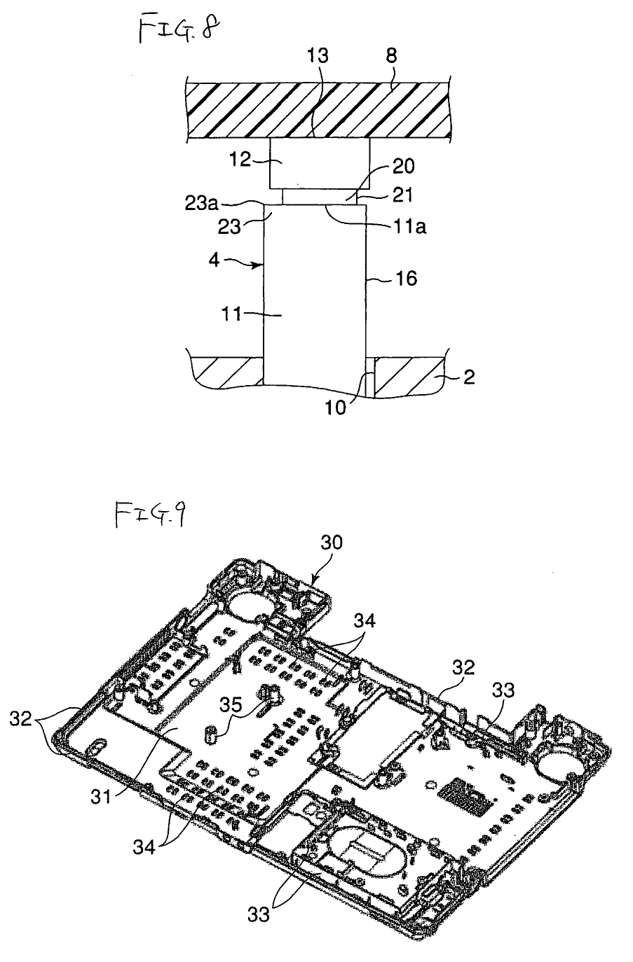

As shown in FIGS. 2 through 5, the head portion 12 of the ejector pin 4 has a diameter smaller than that of the body 11. A first gap 14 is defined between the outer peripheral surface of the head portion 12 and the inner surface of the guide slot 10. The first gap 14 is continuous in the peripheral direction of the head portion 12. Accordingly, the first gap 14 has a ring-like opening shape in which this first gap is open to the molding space 5 in a manner to be continuous in the peripheral direction of the head portion 12.

The size of the first gap 14 is proportional to the clearance S1 between the outer peripheral surface of the head portion 12 and the inner surface of the guide slot 10. The value of the clearance S1 is determined on the basis of, for example, the material properties of the resin material, the filling pressure thereof, and the filling time period thereof.

As shown in FIGS. 4 and 6, the body 11 has a notch 16 which is formed by flatly cutting part of the outer peripheral surface of this body. The notch 16 extends in the axial direction from the upper end of the body 11 toward the lower end thereof. Insofar as the ejector pin 4 lies at the first position, the notch 16 lies inside the guide slot 10. A second gap 17 is defined between the notch 16 and the inner peripheral surface of the guide slot 10. The lower part of the second gap 17 is contiguous to an air escape port 18 which is formed in the first metal mold 2. The air escape port 18 is open to the exterior of the first metal mold 2.

The ejector pin 4 has a groove portion 20 between the body 11 and the head portion 12. The groove portion 20 is continuous in the peripheral direction of the ejector pin 4. Insofar as the ejector pin 4 lies at the first position, the groove portion 20 lies inside the guide slot 10. The clearance S2 between the bottom of the groove portion 20 and the inner surface of the guide slot 10 is larger than the clearance S1 between the outer peripheral surface of the head portion 12 and the inner surface of the guide slot 10.

Therefore, the groove portion 20 defines a constricted part 21 between the body 11 and head portion 12 of the ejector pin 4, and the first gap 14 and second gap 17 are contiguous to the constricted part 21. In other words, the first and second gaps 14 and 17 communicate with each other through the groove portion 20.

As a result, the first gap 14, groove portion 20 and second gap 17 define a vent passage 22 between the outer peripheral surface of the ejector pin 4 and the inner surface of the guide slot 10. The vent passage 22 is provided between the molding space 5 and the air escape port 18, thereby to connect the molding space 5 and the exterior of the first metal mold 2.

As shown in FIG. 8, when the ejector pin 4 has ascended to the second position, the head portion 12 and groove portion 20 of the ejector pin 4 and the upper end part of the notch 16 contiguous to the groove portion 20 protrude from the inner surface of the first metal mold 2 toward the molding space 5. Therefore, those parts of the ejector pin 4 which constitute the upstream side of the vent passage 22 are exposed out of the first metal mold 2 each time the molded article 8 is pushed up from the first metal mold 2.

The body 11 of the ejector pin 4 has an end surface 11a which is exposed to the groove portion 20, and a right-angled corner portion 23 which is defined by the end surface 11a and the outer peripheral surface of the body 11. The corner portion 23 includes a sharp edge 23a which is continuous in the peripheral direction of the ejector pin 4. The edge 23a lies in slidable touch with the inner surface of the guide slot 10.

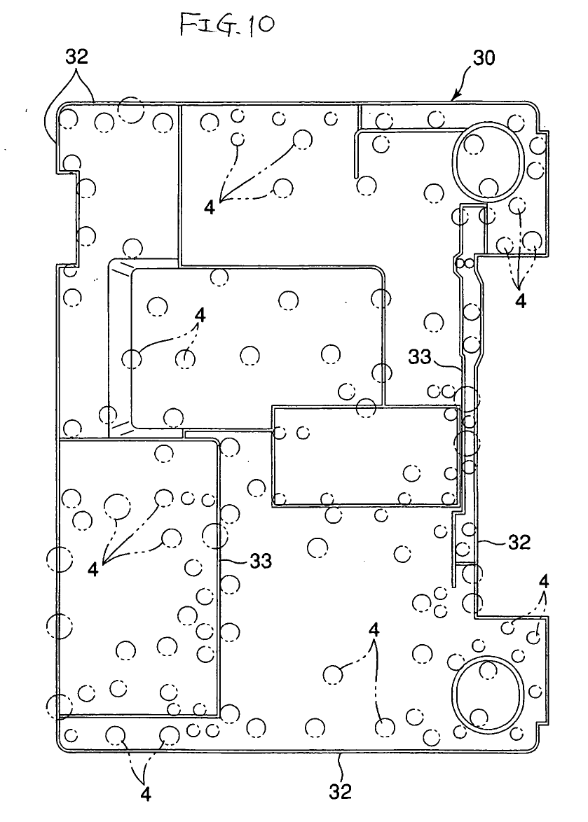

FIG. 9 shows a casing 30 for a portable computer as an example of the molded article 8 fabricated by employing the metal mold apparatus 1. The casing 30 includes a bottom wall 31, a plurality of peripheral walls 32 which rise from the peripheral edge of the bottom wall 31, a plurality of erect walls 33 which rise from the inner surface of the bottom wall 31, a plurality of holes 34 which are provided in the bottom wall 31, and bosses 35. The principal parts of the casing 30 are set at thickness, for example, less than 1 mm. Therefore, the casing 30 itself is thin-walled and has a complicated shape.

In the metal mold apparatus 1 for molding such a casing 30, the ejector pins 4 which are in the number of 100 or more and have different diameters by way of example are assembled in the first metal mold 2. The ejector pins 4 are dispersively arranged over the wide range of the molded article 8 as shown in FIG. 10, in order that the casing 30 after the completion of the molding may be pushed up from the first metal mold 2 without being inclined.

In this embodiment, the vent passages 22 as stated above are provided in the ejector pins 4 which correspond to, for example, 60% of the total number of ejector pins 4. The number of the ejector pins 4 to be provided with the vent passages 22 is determined on the basis of the flow directions of the resin material within the molding space 5, the filling pressure thereof, the material properties thereof, and empirical rules of many years.

In the metal mold apparatus 1 of such a configuration, the vent passage 22 which extends from the molding space 5 to the exterior of the first metal mold 2 is defined between the ejector pin 4 and the guide slot 10. Therefore, when the resin material is poured from the gate 6 into the molding space 5, air remaining in the molding space 5 flows from the first gap 14 into the groove portion 20 in accordance with the flow of the resin material, and it leaks from the groove portion 20 to the exterior of the first metal mold 2 through the second gap 17 as well as the air escape port 18, as indicated by arrows in FIG. 2.

Further, any gas which has been produced with the vaporizations of the additives on the occasion of the pouring of the resin material into the molding space 5 passes through the first gap 14, groove portion 20, second gap 17 and air escape port 18 and leaks to the exterior of the first metal mold 2, likewise to the above air.

In other words, the resin material poured into the molding space 5 is spread uniformly every nook and corner of the molding space 5 while pushing out from the vent passages 22, the air remaining in the molding space 5 and the gas produced at the filling of the resin material. As a result, the flowability of the resin material in the molding space 5 becomes favorable, and the whole molding space 5 can be filled up with the resin material. Accordingly, the molded article 8 in the desired shape can be obtained.

According to the metal mold apparatus 1, the air and gas within the molding space 5 can be drawn out from the place of the ejector pin 4, a dedicated core pin or core block for degassing is eliminated. As compared with the related art, accordingly, the embodiment can simplify the configuration of the metal mold apparatus 1 and decrease the number of components thereof, and it can reduce the cost of the metal mold apparatus 1.

Also, the ejector pins 4 are arranged in balanced fashion so as to disperse over the wide range of the molded article 8, and hence, positions where the air and gas within the molding space 5 are drawn out are not restricted. Therefore, the air and gas within the molding space 5 can be efficiently drawn out from a large number of places in the molding space 5, and the flowability of the resin material within the molding space 5 can be enhanced.

On the other hand, in the metal mold apparatus 1, the first gap 14 located at the upstream end of the vent passage 22 is open to the molding space 5, so that part of the resin material and part of the gas might flow into this first gap 17. Especially the gas becomes a pasty or tarry foreign matter, which adheres to the inner surface of the guide slot 10 or the outer peripheral surface of the head portion 12 of the ejector pin 4.

In such a case, scavenge operations are carried out for removing the resin material or the foreign matter which has adhered to the ejector pins 4 or the guide slots 10. Specifically, in a state where the first metal mold 2 and the second metal mold 3 have been opened and where the molded article 8 has been pushed out by the ejector pins 4 and taken out, the ejector pins 4 are in a state where they have ascended to the second position. On this occasion, at least the head portions 12 and groove portions 20 of the ejector pins 4 and the upper parts of the bodies 11 thereof protrude from the inner surface of the first metal mold 2 toward the molding space 5, and they are exposed out of the first metal mold 2.

It is therefore possible to easily remove the resin material and the foreign matter which have adhered to the head portions 12, the groove portions 20, and the upper parts of the bodies 11.

Moreover, according to the metal mold apparatus 1, the corner portion 23 of the body 11 of the ejector pin 4 has the sharp edge 23a which is continuous in the peripheral direction of the guide slot 10. This edge 23a is held in slidable touch with the inner surface of the guide slot 10 when the ejector pin 4 ascends from the first position to the second position. Therefore, the resin material and the foreign matter which are adherent on the inner surface of the guide slot 10 are automatically scraped off from the inner surface of the guide slot 10 by the edge 23a of the body 11 during the ascent of the ejector pin 4. The resin material and the foreign matter which have been scraped off are led to the groove portion 20, and they are taken out of the first metal mold 2 in a state where they are held in the groove portion 20.

For the above reasons, even when the resin material and the tarry foreign matter have intruded into the first gaps 14 of the vent passages 22, the scavenge operations of the vent passages 22 can be carried out without disassembling the metal mold apparatus 1. Accordingly, there is the advantage that the production activity of the molded article 8 need not be stopped for a long time period as in the prior art, and that the productivity of the molding is remarkably enhanced.

Further, since the first gap 14 is continuous in the peripheral direction of the guide slot 10, the head portion 12 of the ejector pin 4 may merely be formed columnar. Therefore, the head portion 12 need not be subjected to complicated machining, and the cost of the ejector pin 4 can be reduced.

Incidentally, the present invention shall not be limited to the foregoing embodiment, but it can be variously modified and performed within a scope not departing from the purport thereof.

In the embodiment, the vent passages are provided at the positions which correspond to the ejector pins protruded toward the molding space. However, the invention is not restricted thereto, but in a case, for example, where the first metal mold has pins which are not accompanied by the ejecting operations, or pins which are protruded to the molding space, vent passages may well be provided at parts corresponding to these pins.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A metal mold apparatus comprising:
a pair of metal molds defining a molding space into which a melted resin material is filled; and
an ejector pin provided in one of the metal molds and capable of protruding toward the molding space;
wherein the ejector pin has a vent passage which connects the molding space and the exterior of the one metal mold.

2. The metal mold apparatus as defined in claim 1, wherein the one metal mold has a guide slot in which the ejector pin is fitted so as to be slidable in its axial direction, and the vent passage is defined between an outer peripheral surface of the ejector pin and an inner surface of the guide slot.

3. The metal mold apparatus as defined in claim 2, wherein the ejector pin includes a body which is slidably fitted in the guide slot, and a head portion which is provided at a distal end of the body and which has a pressing face for pushing out a molded article; the vent passage includes a first gap defined between an outer peripheral surface of the head portion and an inner surface of the guide slot, and a second gap defined between part of an outer peripheral surface of the body and the inner surface of the guide slot; and the first gap has an opening shape which is continuous in a peripheral direction of the head portion and which is open to the molding space, while the second gap is continuous to the first gap and which extends in an axial direction of the body.

4. The metal mold apparatus as defined in claim 3, wherein the ejector pin has a groove portion which is continuous in a peripheral direction of the ejector pin, between the head portion and the body; and the first and second gaps communicate with each other through the groove portion.

5. The metal mold apparatus as defined in claim 4, wherein a clearance between a bottom of the groove portion and the inner surface of the guide slot is larger than a clearance between the outer peripheral surface of the head portion and the inner surface of the guide slot.

6. The metal mold apparatus as defined in claim 5, wherein the body of the ejector pin has an end surface exposed to the groove portion, and a corner portion defined between the end surface and the outer peripheral surface of the body; and the corner portion includes a sharp edge being in slidable contact with the inner surface of the guide slot.

7. The metal mold apparatus as defined in claim 4, wherein the outer peripheral surface of the head portion and the groove portion are protruded from the one metal mold toward the molding space when the ejector pin has been moved to a position at which the molded article is pushed out from the one metal mold.

8. A metal mold apparatus comprising:
a pair of metal molds defining a molding space into which a melted resin material is filled; and
a plurality of ejector pins provided in one of the metal molds and capable of protruding toward the molding space;
wherein vent passages which extend from the molding space to the exterior of the one metal mold are formed between, at least, some of the ejector pins and the one metal mold, and an upstream end of each of the vent passages is open to the molding space and has an opening shape which is continuous in a peripheral direction of the corresponding ejector pin.

9. The metal mold apparatus as defined in claim 8, wherein the one metal mold has guide slots in each of which the corresponding ejector pin is fitted so as to be slidable in its axial directions, and each vent passage is defined between an outer peripheral surface of the corresponding ejector pin and an inner surface of the corresponding guide slot.

10. The metal mold apparatus as defined in claim 9, wherein each ejector pin includes a body which is slidably fitted in the corresponding guide slot, a head portion which is provided at a distal end of the body and which has a pressing face for pushing out a molded article, and a groove portion which is provided between the body and the head portion and which is continuous in the peripheral direction of the corresponding ejector pin; each vent passage includes a first gap which is annular and which is defined between the outer peripheral surface of the head portion and the inner surface of the corresponding guide slot, and a second gap which is defined between part of an outer peripheral surface of the body and the inner surface of the corresponding guide slot and which extends in an axial direction of the body; and the first and second gaps communicate with each other through the groove portion.

11. A metal mold apparatus comprising:
a pair of metal molds defining a molding space into which a melted resin material is filled;
a pin provided in one of the metal molds and exposed to the molding space; and
a vent passage which is provided between the pin and one metal mold, and which extends from the molding space to the exterior of the one metal mold.

12. The metal mold as defined in claim 11, wherein the vent passage has an upstream end which is open to the molding space; and the upstream end has an opening shape which is continuous in a peripheral direction of the pin.
